(19) United States
(12) Patent Application Publication
(10) Pub. No.: US 2010/0071187 A1
(43) Pub. Date: Mar. 25, 2010

(54) METHOD AND DEVICE FOR INSTALLING AND REMOVING A PLASTICIZING SCREW

(75) Inventors: Robert Weinmann, Weesen (CH); Placi Wenzin, Walenstadt (SE); Marcel Zahner, Benken (SE)

Correspondence Address: HENRY M FEIEREISEN, LLC;HENRY M FEIEREISEN, 708 THIRD AVENUE, SUITE 1501, NEW YORK, NY, 10017, US

(73) Assignee: Netstal-Maschinen AG, Nafels (CH)

(21) Appl. No.: 12/516,464

(22) PCT Filed: Dec. 4, 2007
(86) PCT No.: PCT/EP07/63209

§ 371 Date: May 27, 2009

(30) Foreign Application Priority Data
Dec. 5, 2006 (CH) 01976/06
Mar. 2, 2007 (CH) 00341/07

(51) Int. Cl. B23P 19/04

(52) U.S. Cl. 29/426.5; 29/240

(57) ABSTRACT

The invention relates to a method and a device for installation and removal of the plasticizing screw (1) of a piston or drive end (11) of a screw drive system of an injection molding machine by means of a clamp coupling (10). The screw drive system is designed for a controlled linear and rotary movement of the plasticizing screw (1). The coupling is realized via clamping means which are preferably in the form of mechanical clamp coupling (10), wherein the rotary driving power and the screw return force are transferred via frictional engagement, and the axial injection force is transferred via an end stop. The installation and removal operation is supported by being controlled by the screw drive system. The plasticizing screw (1) can also be coupled or decoupled via a releasable compression connection implemented as a heat-shrinkage connection or as a hydraulic tension system (23), wherein the plasticizing screw (1) is introduced during coupling to the end stop.

### TECHNICAL FIELD

The invention relates to a method for installing and removing the plasticizing screw from a piston or drive end of a screw drive system of an injection molding machine by means of a releasable coupling, wherein the screw drive system is constructed for controlled linear and rotational movements of the plasticizing screw.

The invention also relates to a device for installing and removing the plasticizing screw from a piston or drive end of a controlled screw drive system of an injection molding machine by way of a releasable coupling.

### STATE OF THE ART

The core components of injection molding machines include on the injection site the entire injection unit, which includes the injection unit and the drive system for the plasticizing screw as well as the plasticizing unit with the plasticizing screw. The entire injection installation is supported for movement by special drives, so that the nozzle tip of the plasticizing unit can be moved towards and away from the injection opening of the injection mold as well as pressed against the injection mold.

The central supplementary function for the plasticizing unit is the installation and removal at the injection molder. Installation and removal is required when a screw of different size or geometry needs to be installed, or for example before extended downtimes, when both parts need to be cleaned. The plasticizing unit is composed of a plasticizing cylinder, a plasticizing screw and a pellet feed hopper. During removal, the pellet feed hopper must be released first and moved away from the plasticizing cylinder far enough, so that the plasticizing cylinder with the plasticizing screw can be lifted out of the machine with a crane and then reinserted again during installation.

Aside from the mold clamping side, the greatest forces in an injection molding machine are produced in the region of the injection unit and the plasticizing cylinder as well as the plasticizing cylinder screw. The axial forces alone resulting from the maximum pressure buildup in the injection mold can reach between 10 and 50 tons, equivalent to forces encountered, for example, during stamping and forging. All components of an injection molding machine subjected to the largest forces are therefore of a very massive construction. This applies also to the screw coupling and the cylinder coupling. Each coupling half is connected with several large coupling screws.

With most conventional solutions, the cylinder coupling primarily supports the weight of the unsupported overhang of the plasticizing cylinder. The screw coupling, on the other hand, must transmit the large axial forces for maximal pressure buildup as well as the rotational forces for charge-wise metering of the melt from the two screw drives. The screw drive system has two independently controllable drive motors, for example servo motors. Both movements are transmitted via a gear block and a drive end. The screw coupling connects the drive end directly with the plasticizing screw.

Several embodiments of the screw coupling are known from practical applications, for example a spline shaft engagement. Also known, for example from GB 1 094 037, is a threaded connection. Another less-expensive coupling is a strap-like connection, where two clampable half shells connect the drive end with the corresponding end of the plasticizing screw with clamping screws. Practical applications have demonstrated that a spline shaft or threaded connection is optimal for centering the plasticizing screw. A strap-like connection is less expensive, but can have disadvantages with respect to centering.

Disadvantageous, with the conventional solutions, installation and removal of the plasticizing screw requires considerable time and the corresponding components are relatively expensive.

It is therefore an object of the invention to arrive at a solution which reliably transmits all forces, provides optimal centering, can be inexpensively manufactured, and requires short installation and removal times of the plasticizing screw.

### SUMMARY OF THE INVENTION

The method of the invention is characterized in that coupling is attained with mechanical clamping means, wherein the rotational drive force and the screw pull-back force is transmitted through frictional engagement and the axial injection force is transmitted by way of a stop, and the installation and removal process is controllably supported by the screw drive system.

The device of the invention is characterized in that the coupling elements are constructed as releasable clamping means, such that the rotational drive force and the screw pull-back force can be transmitted through frictional engagement and the axial injection force can be transmitted by way of an axial stop.

The novel invention provides three conceptual embodiments, on one hand a mechanical coupling process, and on the other hand a hydraulic or thermal coupling process.

The method of the invention is based on the fact that the injection molding machine and/or the screw drive system is configured for a controlled linear and rotational movement of the plasticizing screw, wherein for both movements the force is monitored during the entire injection molding process or injection molding cycle. The novel invention uses this aspect in that the installation and removal process is supported by two corresponding additional supplementary programs in the controller of the screw drive system. This approach provides an ideal combination of mechanical coupling means with a supplementary control and monitoring of the corresponding positions during installation and removal. As will be described hereinafter, the installer only needs to manually operate a locking bar and tighten the clamping screws, in addition to the two control commands (installation program and removal program). Even if he forgets to do this, the error can be immediately announced by the force monitoring system, thus preventing a corresponding dangerous situation.

The method of the invention provides several particularly advantageous embodiments. Reference is made here to claims 2 to 9.

In a particularly preferred embodiment, after installation of the plasticizing unit, the plasticizing screw is for the coupling operation fixed in the axial direction and the piston or drive end is advanced with a slight rotation in the direction of a plasticizing screw coupling element while monitoring the force. The controller is used for trouble-free coupling, in the same manner as an installer would do manually. One component is not simply pushed into the other component, but rather inserted with a slight rotation. A fault situation would be indicated immediately by the force monitoring system, thus preventing a corresponding malfunction.

Preferably, as soon as force monitoring is triggered according to a corresponding preset, the advance movement is stopped with a residual axial play and the piston or drive end is rotated while being monitored by a sensor, until the clamping screws assume an optimal clamping position, the clamping screws are tightened, and the fixation of the plasticizing screw is released. The residual play, until the coupling elements make complete contact, is removed only by the melt pressure in the first injection cycle. During removal, the process is just reversed according to an removal program. For removal, the plasticizing screw is advanced to a forward screw position, rotated into an optimal position for releasing the clamping screws, and the position of the plasticizing screw is fixed in the axial direction. After the clamping screws are released, the coupling elements are pulled apart through slight rotation of the piston or drive end, while the force is monitored. The location of the plasticizing screw is fixed in the axial direction with a locking bar, and the clamping screws are tightened by hand.

The device of the invention according to a first solution approach attains three unexpected advantages within the framework of the screw coupling:
According to the first advantage, the coupling components can be produced from the solid material of the drive end, thereby generating less waste.
According to the second advantage, the entire interior clamping form can be produced in a single process step by providing a pocket hole in the drive end
According to the third advantage, the plasticizing screw is centered in the drive end during clamping and/or in the coupled state.

This provides a complete solution of the object of the invention.

According to a particularly advantageous embodiment, this centering bore is implemented as a pocket hole, wherein the end of the pocket hole forms a stop face for the coupling element of the plasticizing screw. The centering bore is located in the non-weakened part of the drive end and simultaneously forms the rear stop during installation of the plasticizing screw for transmitting the largest axial forces from the maximum pressure buildup in the injection mold.

The device of the invention provides several solution approaches. For a first solution approach, reference is made to claims 10 to 13, and for a second solution approach to claims 14 to 26.

According to the first solution approach, both half shells are formed on the drive end itself and form a single piece with the piston or drive end. However, they are separated in the direction toward the plasticizing screw axis parallel to the rotation axis for mutual clamping. The drive end itself hence forms the entire coupling. No other coupling elements are required aside from the clamping screws. The solution can not only be manufactured very cost-effectively, but also makes it possible to produce the coupling elements with the smallest possible waste. Almost no waste is generated when these components are produced by drop forging. Preferably, the separation extends beyond the region of the clamping screws to near the stop face. Advantageously, an annular groove is arranged in the drive end immediately before the stop face, as viewed in the direction of the clamp coupling, for enhancing a spring action for clamping the two half shells. During installation, the plasticizing screw coupling element is inserted first in the pocket hole of the two half shells and maximally centered by the centering bore for the last millimeter of insertion travel. The position of the plasticizing screw in the direction of the plasticizing screw axis is thereby necessarily defined at the stop. The zero calibration position for controlling/regulating the axial travel is reestablished after each installation, but no later than following the first charge. Preferably, the two half shells are produced by a bore located in the drive end and being larger by a slight play in a range of tenths of millimeters than the corresponding plasticizing screw coupling element. Spacers disposed between the half shelves for bridging different diameters of the plasticizing screw coupling element may also be provided.

According to the second solution approach, the clamp coupling includes two half shells as well as a tongue connection, wherein the half shells and the tongue connection have an interior shape that matches the plasticizing screw coupling element. Preferably, the tongue connection is formed from two tongues which are constructed as a single piece as part of the piston or drive end. The half shells are made of those parts that were separated from the piston or drive end when the two tongues were fabricated. As an important component of the novel solution, a centering bore with a preferably flat stop face for the plasticizing screw is arranged in the drive end also when implementing the second solution approach. This provides the following advantages for both solutions: the largest forces from the maximal pressure buildup are transmitted not via the coupling, but directly via the two end faces of the centering bore of the drive end and of the plasticizing screw. During each new coupling process, the plasticizing screw is exactly positioned in relation to the drive end. A zero or calibration position is then always reestablished for the linear movement of the plasticizing screw, which can be attained with a threaded solution only by increasing the complexity. Advantageously, the clamping form of the clamp coupling in both the half shells and the two tongues is formed by a bore in the drive end. These measures help to most reliably ensure that the plasticizing screw is centered relative to the drive end during the coupling process. Preferably, the clamping form has a circular cylindrical shape, so that the plasticizing screw can be inserted into the tongue connection in any rotational position. The circular cylindrical shape can be produced very cost-effectively. The clamping depth through the half shells corresponds approximately to the length of the tongues. A play of several millimeters may result from the manufacturing process, because the half shells must be separated from the drive end. This also ensures that the plasticizing screw is always inserted until it contacts the stop face of the centering bore.

According to another solution approach, the two half shells are clamped with at least two screws, wherein the tongues have a through bore, which is preferably fabricated as a tight-fitting bore having a small play with respect to the screws. One half shell has a thread whereas the other half shell has a through bore. As described above, all pressure forces resulting from the pressure buildup in the melt are absorbed by the stop face. The forces resulting from the screw rotation are transmitted as shear forces via the screw connection. In a particularly advantageous embodiment, the half shells and the tongue connection have identical inside diameters for precisely centering the plasticizing screw coupling element with respect to the drive end. In this way, the coupling process does not allow a deviation from the center, because the bore in the half shells and the tongue connection is identical as a result of the manufacturing process.

Advantageously, the plasticizing screw according to the second and third conceptual embodiment is implemented and installed and uninstalled, respectively, with a releasable compression connection constructed as a heat shrink connection or as a hydraulic clamping system, wherein the plasticizing screw is inserted during coupling until it contacts the stop, and the screw coupling is implemented as releasable compression fit by way of a clamping sleeve.

Unlike with conventional machine tools where changing, for example, a milling head involves only a single element, injection molding machine always require simultaneous installation or removal of two elements, wherein the plasticizing screw remains in the plasticizing cylinder for coupling and decoupling. The inventors have recognized that the more demanding aspect resides in releasing and connecting the plasticizing screw to the drive end of the screw drive system. When the very heavy and still partially hot plasticizing cylinder is removed with a crane, only weight-related forces can be absorbed. Accordingly, in conventional approaches, both the cylinder coupling and the screw coupling were implemented as flange couplings. The rather confined space in the coupling region makes it very difficult to install a pulling device for the plasticizing screw. The concept of an injection molding machine is favorable for the solution of the invention in that the plasticizing screw already incorporates a linear drive by which the plasticizing screw is moved by corresponding electric or hydraulic drives relative to the plasticizing cylinder and the injection molding unit. Accordingly, an injection molding machine already includes a pulling aid for the plasticizing screw to apply the required forces when the plasticizing cylinder is inserted or retracted when the press connection is released. Linear movement for insertion and retraction can then be performed very precisely. As will be described below with reference to preferred embodiments, the novel invention can be implemented with modestly higher costs, thus facilitating the process in practical applications, simplifying handling and also shortening installation and removal time.

According to a particularly advantageous embodiment of the method, the forces of the cylinder coupling are transmitted via a flange connection and, in particular, the rotational forces of the screw coupling are transmitted via the cylindrical face of a clamping sleeve. The cylinder coupling may be implemented, for example as conventionally, as flange coupling. The screw coupling is preferably configured with a clamping sleeve. The linear movement of the plasticizing screw in the cylinder is blocked during the coupling process, whereby the plasticizing screw is not pulled out, but instead the clamping sleeve is pulled away. Preferably, the coupling shaft of the plasticizing screw is retracted from and inserting into the clamping sleeve of the compression connection by the drive means for the linear movement of the plasticizing screw with a corresponding service control. A corresponding function can be easily integrated or programmed in the machine control. Likewise, with the solution approach employing a heat-shrink connection, the heating phase can be programmed as a service function as part of the machine control. The heat-shrink sleeve is heated by at least one externally applied heat source, whereby the plasticizing screw is rotated during heat-up to evening out the heat. It is sufficient if the heat source operates only along a stripe extending over the entire length of the clamping sleeve. The entire clamping sleeve is then uniformly heated as a result of the rotation of the coupling elements. According to another advantageous embodiment, simple conventional manual wrenches are used for coupling and decoupling. For applying larger forces, the elements of the injection molding machine are used, which already exist for the mechanical elements.

Regarding the device, the thermal clamping system has a clamping sleeve, into which the coupling shaft of the plasticizing screw can be inserted up to the stop in the clamping sleeve. The linear movement of the plasticizing screw must be very precisely controlled for the injection function. Insertion to the stop guarantees a precise zero or starting position for the linear drive of the plasticizing screw in normal production.

With the hydraulic system, a pressure chamber for the pressure medium is provided between a support body and the clamping sleeve, with a connecting bore to a pressure antechamber of a pressure piston. The pressure piston is preferably implemented as a floating body and can be freely pushed in or released for building up the pressure in the pressure antechamber with a manual wrench engaging an external adjustment screw. The hydraulic clamping system forms with the pressure chamber, the connecting bore and the pressure antechamber a closed hydraulic system.

### BRIEF DESCRIPTION OF THE INVENTION

The novel invention will now be described with reference to several exemplary embodiments in more detail.

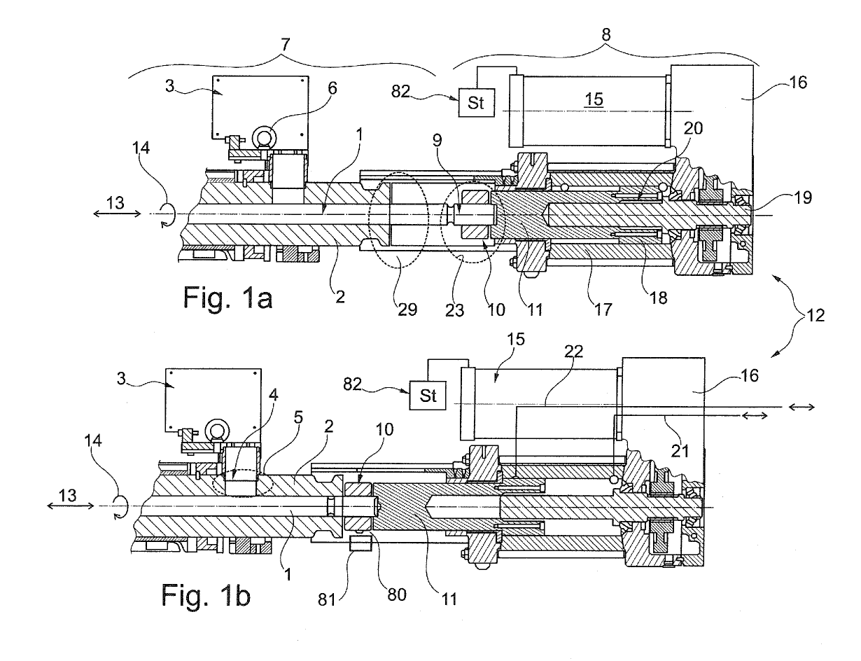

FIG. 1a shows a detail of the plasticizing unit and the injection unit in the area of the screw coupling with retracted plasticizing screw;

FIG. 1b corresponds to FIG. 1a, however with forward position of the plasticizing screw;

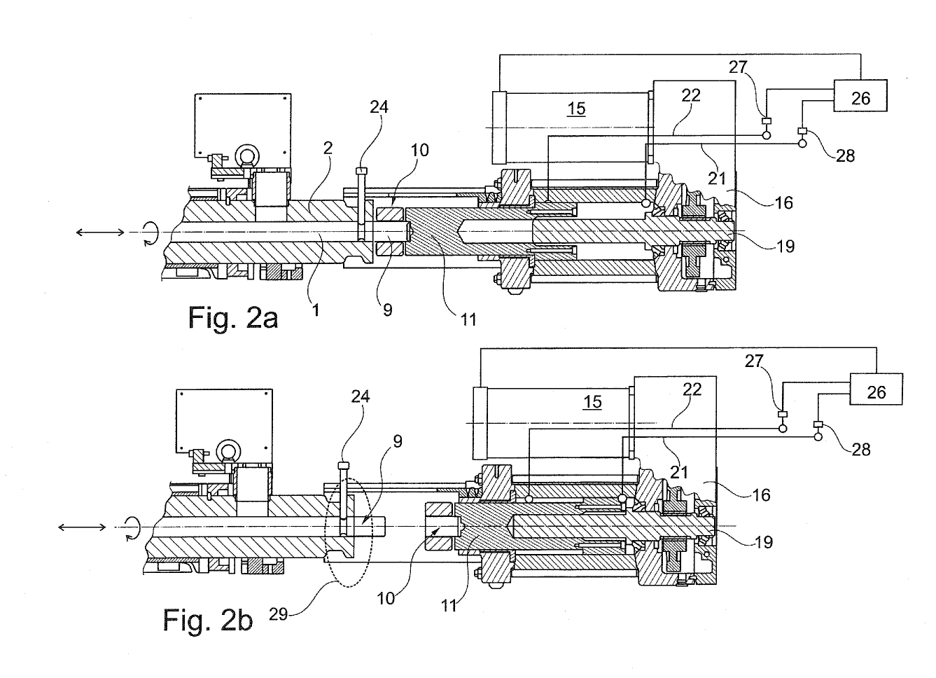

FIG. 2a corresponds to FIG. 1b, however with blocking of the plasticizing screw in the plasticizing cylinder, the start of the mechanical decoupling from the plasticizing screw drive;

FIG. 2b shows the end of decoupling of the plasticizing screw with retracted drive end of the plasticizing screw drive;

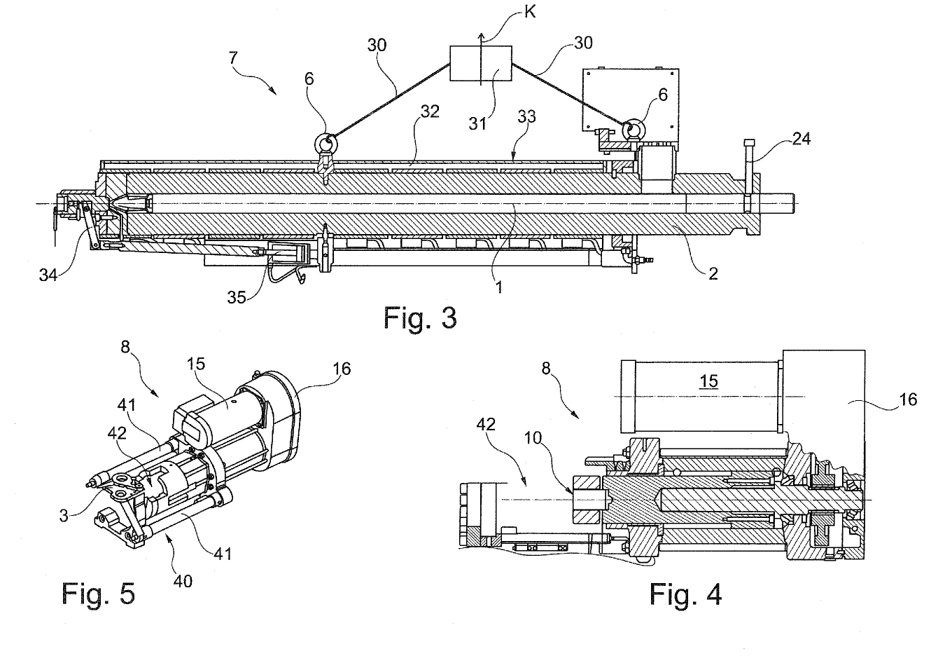

FIG. 3 shows the plasticizing unit with plasticizing cylinder and plasticizing screw, completely uninstalled;

FIG. 4 shows the injection unit with removed plasticizing unit;

FIG. 5 shows the entire injection unit in a perspective view;

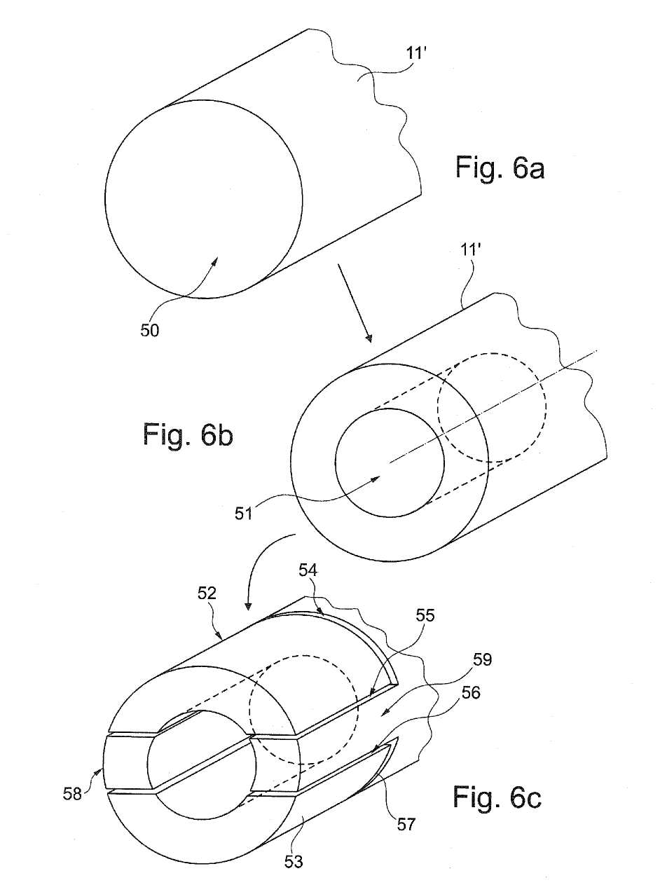

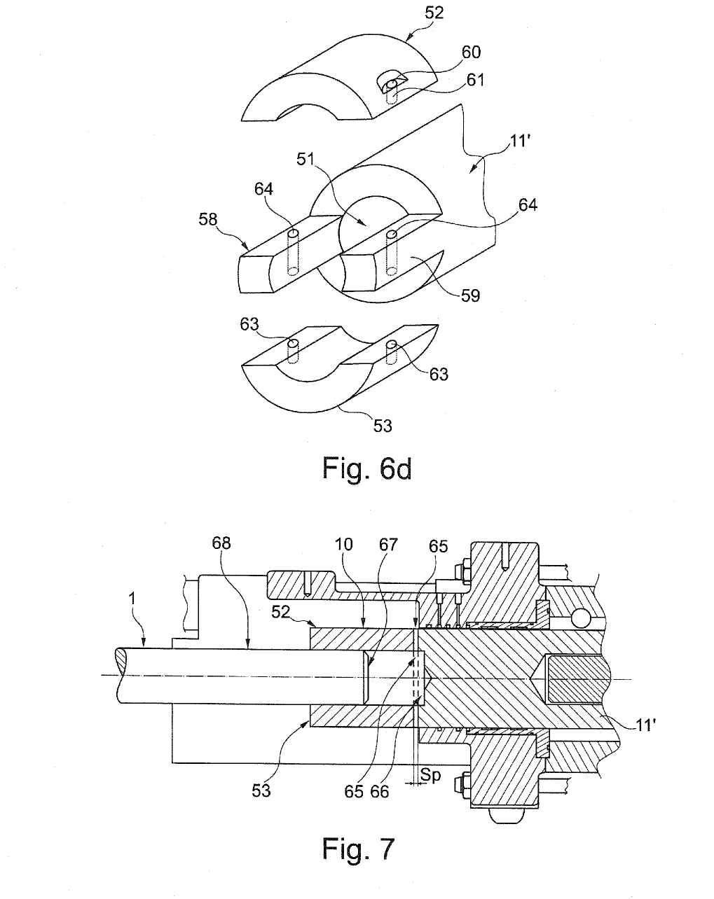

FIGS. 6a-6d shows forming the clamp coupling according to the second solution approach, FIG. 6a the raw drive end, FIG. 6b with a bore in the drive end, FIG. 6c the separation of the two half shells, and FIG. 6d an exploded view of the drive end with the two tongues and the two half shells;

FIG. 7a shows a longitudinal cross-section through the screw coupling of FIGS. 6a to 6d;

FIG. 7b shows a longitudinal view of the screw coupling;

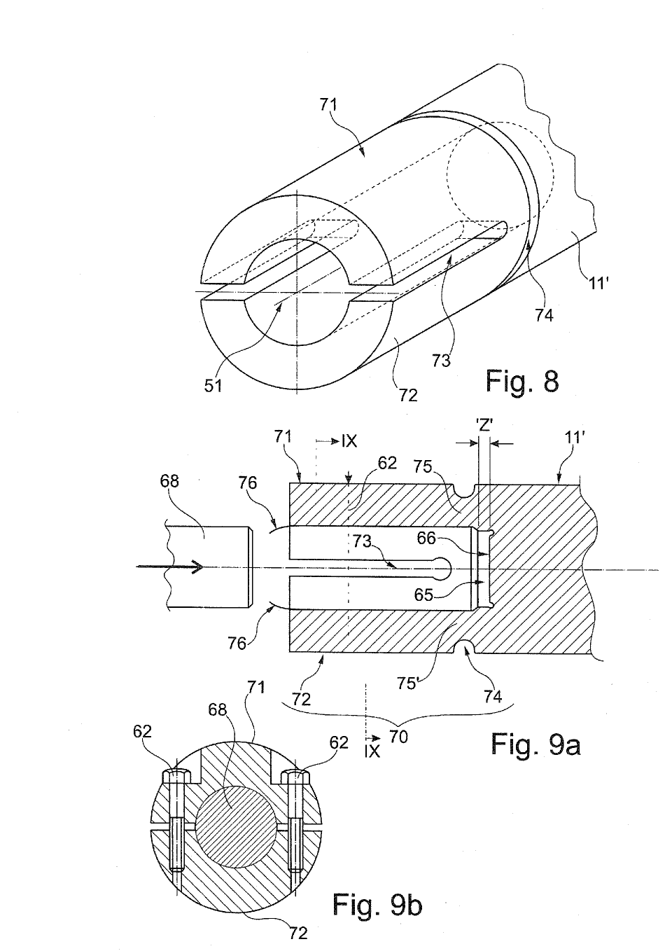

FIGS. 8, 9a and 9b show a clamp coupling according to the first solution approach, wherein FIG. 8 is a perspective view, FIG. 9a a cross-section, and FIG. 9b a section taken along the line IX-IX in FIG. 9a;

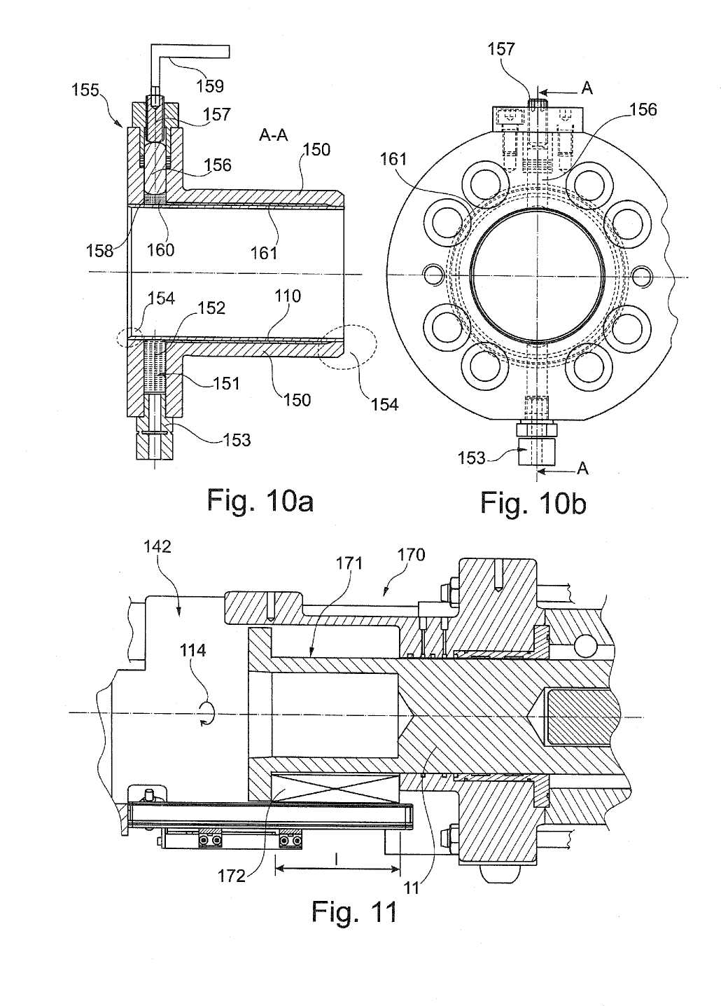

FIGS. 10a and 10b show a hydraulic clamping system in a cross-sectional and front view on an enlarged scale; and

FIG. 11 shows schematically a thermal clamping system with removed plasticizing screw.

### APPROACHES AND IMPLEMENTATION OF THE INVENTION

References now made to FIGS. 1a and 1b, which show the area of the couplings with the plasticizing screw 1 in a retracted position (FIG. 1a) and in a forward position (FIG. 1b). The left part of the Figure illustrates the plasticizing cylinder 2 with a support structure 3 for a pellet feed hopper. The pellets, while still dry, are fed via a feed opening 4 into the feed region of the plasticizing screw 1. Also shown is a support ring 6 for installation and removal of the plasticizing unit 7 with a crane (not shown). The rear section of the plasticizing screw 1 includes a coupling shaft 9 which is coupled into a clamp coupling 10 of a drive end 11 of the injection unit 8. The drive unit 12 is configured for the two different movements of the plasticizing screw 1, namely a linear movement, corresponding to the arrow 13, and a rotational movement, corresponding to the arrow 14. The rotational movement is produced by a drive motor 15 and a gear 16. According to the example of FIGS. 1 and 2, the linear movement is produced hydraulically. A hydraulic piston 18, which is screwed directly to the drive end 11, is arranged in a hydraulic cylinder 17. The drive shaft 19 from the gear 16 has a keyway located in the region of the drive end 11, which transmits the rotational movement of the drive motor 15 to the drive end 11. Hydraulic oil is supplied to and removed from the hydraulic cylinder 17 through oil lines 21, 22, enabling the drive end to travel forward or backward. Depending on the actual situation within an injection cycle, for example during metering or filling the mold, the drive is activated for the linear movement or for the rotational movement.

Advantageously, the screw coupling is released first during removal of the plasticizing unit 7, as illustrated in FIG. 2a. Hydraulic oil is supplied through the oil line 21, moving the drive end 11 to the forward position (FIGS. 1a and 2a). In this position, the plasticizing screw 1 can be locked with a retention pin 24 to prevent longitudinal movement of the plasticizing screw 1 relative to the plasticizing cylinder. At the next step, the screw coupling is released, as will be described below with reference to FIGS. 6, 7a and 7b. The valves 27 and 28 are switched by a machine control 26 running a service program, pulling the drive end 11 together with the clamping sleeves away from the coupling shaft 9 (see FIG. 2b). The plasticizing screw 1 is then completely decoupled. At the next step the cylinder coupling 29 is released, while the plasticizing unit 7 is suspended on a cable 30 from a crane (k) 31 (FIG. 3). After the cylinder coupling 29 is released, the plasticizing unit 7 can be lifted and transferred to the cleaning department. The coupling process takes place in the reverse order. Accordingly, the devices and manual wrenches already present on the injection molding machine are primarily used for the entire process.

FIG. 3 shows the plasticizing unit 7 before installation and after removal, respectively. The plasticizing cylinder is heated by heating elements 32 and protected by a cover 33 to prevent operating personnel from “burning their fingers.” When removing the plasticizing unit 7, the operator comes only into contact with the support rings 6 and manual wrenches. FIG. 3 shows additional devices, such as a nozzle closure 34 and a nozzle closure drive 35. These are not part of the novel invention, but can remain, like in conventional machines, on the plasticizing unit 7 during installation/removal.

FIG. 4 shows the injection unit 8 without the plasticizing unit 7.

FIG. 5 is a perspective view showing the injection unit 8. The left side of the drawing page illustrates a supplementary device 40 with two supplementary cylinders 41 for moving away the support structure 3 for the feed hopper. As seen in FIGS. 4 and 5, there is sufficient unobstructed space 42 before installation of the plasticizing unit 7 for inserting the cylinder coupling elements from above.

FIGS. 6a to 6c show the three main manufacturing steps for the coupling elements. FIG. 6a shows the raw drive end 11′ with a planar end face 50, in which according to FIGS. 6b a coupling bore in form of a pocket hole is disposed. FIG. 6c shows the next step, namely separation of the two half shells 52, 53, for example by way of four saw cuts 54, 55, 56 and 57. Two tongues 58, 59 are left which remain connected as a single piece with the drive end 11′.

FIG. 6d shows an exploded view of the drive end with the two tongues and the two half shells. The upper half shell 52 has already a milled recess 60 with a bore 61 for clamping screws 62. Two threaded holes 63 for the clamping screws 62 are disposed in the lower half shell 53. A corresponding through bore 64 for the shaft of the clamping screws 62 is disposed in each of the two tongues 58, 59.

FIG. 7a shows a cross-sectional view of the screw coupling 23 with the screw coupling element, which is partially inserted into the clamp coupling 10. Importantly, the end face 67 of the plasticizing screw coupling element 68 is inserted into the centering bore 65 until it contacts the stop face 66. Only then are the clamping screws 62 tightened, as shown in FIG. 9b.

FIG. 7b shows the screw coupling 23 and the clamp coupling 10 in a view similar to FIG. 7a, wherein the plasticizing screw 1 is now fully inserted into the centering bore 65, with the clamping screws 62 tightened. FIG. 7b shows the position for semiautomatic installation and removal of the plasticizing screw 1. A signal transmitter 80 and a sensor 81 indicating the rotational position of the clamp coupling allow optimal positioning of the clamping screws 62 with the help of a controller 82 of the screw drive system and the corresponding machine controller, respectively.

Advantageously, the production costs with the solution according to FIGS. 8, 9a and 9b are particularly low. Secure clamping for transmitting the torque for the screw rotation can be produced with sufficient elasticity of the two half shells 71 and 72 by suitable selection of the milling cut 73 and the geometry of the groove 74, advantageously facilitating rapid coupling and decoupling. The plasticizing screw coupling element 68 optimizes centering as well as the zero-position with the stop face 66. FIG. 8 is a perspective view of a corresponding drive end 11. Like FIG. 6b, a coupling bore is disposed in the drive end 11′, which extends over the entire length of the coupling region 70. The centering bore 65 extends over the region “Z” of the pocket hole end, which is delimited by a stop face 66. The two half shells 71 and 72 are produced by a mill cut 73. FIGS. 8 and 9a show an annular groove 74. The annular groove 74 increases the elasticity of the two half shells 71 and 72. Bending is facilitated by removing material in an annular resilient region 75, 75′. When the clamping screws 62 are tightened, the half shells 71 and 72 are springily deflected and produce a sufficiently strong clamping action on the plasticizing screw coupling element 68, as indicated by the arrows 76, 76′ in FIG. 7b. For economic reasons, it may be necessary to couple plasticizing screws with plasticizing screw coupling elements having different diameters to the same drive end. The dimensional differences can be bridged by selecting spacers with different thickness.

FIGS. 10a and 10b show on an enlarged scale the hydraulic clamping system without the plasticizing screw. The innermost part is the clamping sleeve 110, which is surrounded on the outside by a holding element 150 and securely screwed to the drive end. The lower left part shows a fill opening 151 for filling or replenishing hydraulic oil 152. The fill opening 151 is closed with a threaded stopper 153. Both end faces of the clamping sleeve 110 are sealingly pressed or soldered into the holding body 150. The left upper part illustrates an oil pressure generator 155 composed of a pressure piston 156, an adjustment screw 157 and a threaded plug. A pressure antechamber 158 is located below the pressure piston and connected to connecting channel 160 for uniform pressure transfer and venting of the pressure chamber 161. The pressure chamber 161 is formed as a cylindrical space between the holding body 150 and the clamping sleeve 110. Turning a manual wrench 159 or the adjustment screw 157 produces, depending on the rotation direction, either a tremendous oil pressure of, for example, more than 1000 bar, or relieves the pressure completely.

FIG. 11 shows the second embodiment of a heat shrink connection 170. The clamping sleeve 171 can be part of the drive end 11. A heat source 172 arranged over the effective length l of the clamping sleeve 171 transfers the necessary heat for expanding the clamping sleeve 171 along a line. The clamping sleeve is evenly heated through rotation to enable insertion or withdrawal travel of the coupling shaft 9, corresponding to arrow 114. Heat-up can be very rapid, for example within seconds. Cooling starts immediately after the heat source 172 is switched off.

1.-27. (canceled)

28. A method for installing and removing a plasticizing screw connected to a piston or drive end of a screw drive system of an injection molding machine by a releasable coupling element having mechanical clamping means, with the screw drive system enabling controlled linear and rotational movement of the plasticizing screw, said method comprising the steps of:
transmitting a rotational drive force and a screw pull-back force through frictional engagement provided by the clamping means;
transmitting an axial injection force by way of a stop; and
controllably supporting installation and removal with the screw drive system.

29. The method of claim 28, wherein after installation of the plasticizing unit, coupling is performed by fixing an axial location of the plasticizing screw, and monitoring a coupling force while advancing the piston or drive end with a slight rotation towards a plasticizing screw coupling element.

30. The method of claim 29, further comprising the steps of stopping advance of the piston or drive end with a residual axial play when the coupling force exceeds a preset value, and monitoring rotation the piston or drive end until the clamping means assumes an optimal clamping position.

31. A device for installing and removing a plasticizing screw connected to a piston or drive end of a screw drive system of an injection molding machine, wherein the screw drive system is constructed to provide controlled linear and rotational movement of the plasticizing screw, said device comprising a releasable coupling element having mechanical clamping screws, wherein a rotational drive force and the screw pull-back force are transmitted by the clamping screws through frictional engagement, and an axial injection force is transmitted by an axial stop, with control means of the screw drive system supporting the installation and removal.

32. The device of claim 31, wherein the mechanical clamp coupling element comprises at least a half shell or a tongue, which are constructed as a single piece and form a part of the drive end and a clamp connection.

33. The device of claim 31, wherein the piston or drive end comprises a centering bore and an axial stop receiving a coupling portion of the plasticizing screw.

34. The device of claim 31, wherein the drive end comprises two integrally formed half shells having therebetween a partition extending parallel to a rotation axis in a direction facing a plasticizing screw axis to facilitate clamping.

35. The device of claim 34, wherein the partition extends beyond a region of the clamping screws to near a stop face of the axial stop.

36. The device of claim 35, wherein the drive end comprises an annular groove disposed before the stop face, with the annular groove increasing a spring action clamping the two half shells.

37. The device of claim 31, wherein the clamp coupling comprises two half shells and a tongue connection, wherein the half shells and the tongue connection have an interior shape that matches a shape of a coupling portion of the plasticizing screw.

38. The device of claim 37, wherein the tongue connection is formed as a single piece forming a part of the piston or drive end and comprises two tongues, with the half shells comprising parts separated from the piston or drive end during machining of the two tongues.

39. The device of claim 37, wherein the interior shape is formed by a coupling bore disposed in the drive end.

40. The device of claim 38, wherein the coupling element has at least two clamping screws clamping the two half shells, wherein the tongues have a through bore fabricated as a tight-fitting bore having a small play with respect to the screws, with one of the half shells having a thread and the other half shell having a through bore.

41. The device of claim 37, further comprising springy washers arranged between the half shells and the tongue connection for centering the half shells when the plasticizing screw is removed.
